(19) United States
(12) Patent Application Publication
(10) Pub. No.: US 2026/0192930 A1
(43) Pub. Date: Jul. 9, 2026

(54) AERO-PROPULSION SYSTEM WITH IMPROVED PROPULSION EFFICIENCY

(71) Applicant: SAFRAN AIRCRAFT ENGINES, Paris (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/128,287

(22) PCT Filed: Nov. 8, 2023
(86) PCT No.: PCT/FR2023/051747

§ 371 Date: May 8, 2025

(30) Foreign Application Priority Data
Nov. 9, 2022 (FR) FR2211672

(51) Int. Cl. B64D 27/40; B64D 27/12; F01D 5/02

(52) U.S. Cl. CPC B64D 27/402; B64D 27/12; F01D 5/021; F05D 2220/36

(57) ABSTRACT

A propulsion system includes a drive shaft movable in rotation about an axis of rotation, a fan shaft, a fan section comprising a ducted fan rotor driven in rotation by the fan shaft, the fan rotor including plural blades, and a reduction mechanism that couples the drive shaft and the fan shaft in order to drive the fan shaft at a rotation speed lower than the rotation speed of the drive shaft. A thrust density per blade of the fan rotor of the propulsion system being greater than or equal to 1.40×10⁵ and less than or equal to 1.70×10⁵ N/m² where the thrust density per blade is defined based on a thrust generated by the fan rotor measured when the propulsion system is stationary in take-off rating and a diameter of the fan rotor.

### TECHNICAL FIELD

This application relates generally to the field of propulsion systems, and more particularly to aeronautical propulsion systems comprising a ducted fan and having a high or even very high bypass ratio.

### BACKGROUND

A propulsion system generally includes, from upstream to downstream in the direction of gas flow, a fan section, a compressor section that may comprise a low-pressure compressor and a high-pressure compressor, a combustion chamber and a turbine section that may comprise, in particular, a high-pressure turbine and a low-pressure turbine. The high-pressure compressor is driven in rotation by the high-pressure turbine via a high-pressure shaft. The fan and, where applicable, the low-pressure compressor are driven in rotation by the low-pressure turbine via a low-pressure shaft.

Technological research efforts have already led to very significant improvements in the environmental performance of aircrafts. The Applicant takes into account the factors that have an impact on all design and development phases to obtain less energy-intensive, more environmentally friendly aeronautical components and products, the integration and use of which in civil aviation have moderate environmental consequences, with the aim of improving the energy efficiency of aircrafts.

Thus, in order to improve the propulsive efficiency of the propulsion system and reduce its specific consumption as well as the noise emitted by the fan section, propulsion systems with a high bypass ratio BPR (corresponding to the ratio between the flow rate of the secondary air stream and the flow rate of the primary air stream) have been proposed. To achieve such bypass ratios, the fan section can be decoupled from the low-pressure turbine, thus making it possible to independently optimize their respective rotation speed. Generally, the decoupling is achieved using a reduction mechanism placed between the upstream end of the low-pressure shaft and a rotor of the fan section. The rotor of the fan section is then driven by the low-pressure shaft via the reduction mechanism at a rotation speed lower than that of the low-pressure shaft.

However, improving the bypass ratio BPR and the fan pressure ratio involves increasing the fan diameter and, by extension, the outer dimensions of the propulsion system (and therefore its mass and drag), which makes the integration of the propulsion system more difficult in addition to increasing its mass and specific consumption. The flow rate in the high-pressure body and the size of the high-pressure body are also reduced, which imposes limitations on the low-pressure body. Particularly, since the low-pressure shaft is housed in the high-pressure shaft, reducing the size of the low-pressure body (and therefore of the high-pressure shaft) involves reducing the diameter of the high-low-pressure shaft, which can therefore become supercritical. However, a supercritical shaft comprises a bending deformation mode in an operating range of the propulsion system. The dynamics of the low-pressure shaft must then be controlled so that the deformation mode does not appear in a stabilized range to avoid any risk of damaging the propulsion system.

One aim of the present application is to optimize the performance of the propulsion system in terms of specific consumption, mass and drag, while ensuring the possibility of integrating the propulsion system into an aircraft.

To this end, according to a first aspect, there is proposed an aeronautical propulsion system comprising:
a drive shaft movable in rotation about an axis of rotation;
a fan shaft;
a fan section comprising a ducted fan rotor driven in rotation by the fan shaft, the fan rotor comprising a plurality of blades;
a reduction mechanism coupling the drive shaft and the fan shaft in order to drive the fan shaft at a rotation speed lower than the rotation speed of the drive shaft;
   a thrust density per blade of the fan rotor of the propulsion system being greater than or equal to 1.40×10⁵ and less than or equal to 1.70×10⁵ N/m² where the thrust density per blade is defined by the following formula:

$$Thrust density = \frac{FN}{n * {D}^{2}} * 100$$

and where: FN is the thrust generated by the fan rotor and is measured when the propulsion system is stationary in take-off rating in a standard atmosphere and at sea level and is expressed in Newton (N);
n is the number of blades in the fan rotor; and
D is the diameter of the fan rotor, measured in a plane normal to the axis of rotation at an intersection between a tip and a leading edge of the blades of the fan rotor, and is expressed in meters (m).

Some preferred but non-limiting characteristics of the aeronautical propulsion system according to the first aspect are the following, taken individually or in combination:
a power density per blade of the fan rotor is greater than or equal to 3.65×10⁶ and less than or equal to 22.0×10⁶ W/m², preferably greater than or equal to 16.0×10⁶ and less than or equal to 22.0×10⁶ W/m², where the power density per blade of the fan rotor is defined by the following formula:

$$Power density = \frac{power of the fan}{n * {D}^{2}} * 100$$

and where the power of the fan corresponds to the power of the fan rotor and is measured when the propulsion system is stationary in take-off rating in a standard atmosphere and at sea level and is expressed in Watts (W);
the fan section further has a fan compression ratio, corresponding to a pressure ratio between an outlet of the fan rotor and an inlet of the fan rotor less than or equal to 1.45;
the diameter of the fan rotor is comprised between 80 inches and 120 inches inclusive, for example of the order of 90 inches;
the fan section is ducted and a bypass ratio of the propulsion system is greater than or equal to 10, for example comprised between 10 and 35 inclusive, preferably between 10 and 18 inclusive;
the fan section is ducted and a peripheral speed at the tip of the blades of the fan rotor, when the propulsion system is stationary in take-off rating in a standard atmosphere and at sea level, is comprised between 260 m/s and 400 m/s;
a hub-to-tip ratio of the fan rotor is comprised between 0.22 and 0.32;
the propulsion system further comprises a drive turbine and a compressor directly connected by the drive shaft, the drive turbine comprising at least three and at most five stages;
the compressor comprises at least two and at most four stages;
the propulsion system further comprises a high-pressure turbine and a high-pressure compressor connected via a high-pressure shaft, the high-pressure shaft rotating faster than the drive shaft, the high-pressure turbine being a two-stage turbine; and/or
the high-pressure compressor comprises at least eight and at most eleven stages.

According to a second aspect, the present application proposes an aircraft comprising at least one propulsion system, according to the first aspect, fixed to the aircraft via a pylon.

According to a third aspect, the present application proposes a method for dimensioning a propulsion system comprising a reduction mechanism coupling a drive shaft and a ducted fan rotor to drive the fan rotor at a speed lower than a speed of the drive shaft, wherein the fan rotor is dimensioned such that a thrust density per blade of the fan rotor of the propulsion system is greater than or equal to 1.40×10⁵ and less than or equal to 1.70×10⁵ N/m², where the thrust density per blade of the fan rotor is defined by the following formula:

$$Thrust density = \frac{FN}{n * {D}^{2}} * 100$$

and where: FN is the thrust of the fan rotor and is measured when the propulsion system is stationary in take-off rating in a standard atmosphere and at sea level and is expressed in Newton (N);
n is the number of blades in the fan rotor; and
D is the fan diameter, measured in a plane normal to the axis of rotation at an intersection between a tip and a leading edge of the blades of the fan rotor, and is expressed in meters (m).

Optionally, the fan rotor (9) is further dimensioned such that a power density per blade (14) of the fan rotor (9) is greater than or equal to 3.65×10⁶ and less than or equal to 22.0×10⁶ W/m², preferably greater than or equal to 16.0×10⁶ and less than or equal to 22.0×10⁶ W/m², where the power density per blade of the fan rotor is defined by the following formula:

$$Power density = \frac{power of the fan}{n * {D}^{2}} * 100$$

and where the power of the fan rotor is measured when the propulsion system is stationary in take-off rating in a standard atmosphere and at sea level and is expressed in Watts (W).

According to a fourth aspect, the present application proposes a method for manufacturing a propulsion system comprising the following steps:
dimensioning the propulsion system in accordance with the third aspect; and
manufacturing the propulsion system.

### DESCRIPTION OF THE FIGURES

Other characteristics, aims and advantages will emerge from the following description, which is purely illustrative and non-limiting, and which should be read in relation to the appended drawings, in which:

FIG. 1 is a schematic, partial, sectional view of one example of a propulsion system in accordance with one embodiment, in which the fan section is ducted;

FIG. 2 is a schematic sectional view of one example of a star reduction mechanism;

FIG. 3 is a schematic sectional view of one example of a planetary reduction mechanism;

FIG. 4 is one example of an aircraft that may comprise at least one propulsion system in accordance with one embodiment;

FIG. 5 is a flowchart illustrating examples of steps in a dimensioning or manufacturing method in accordance with one embodiment of the invention.

Throughout the figures, similar elements bear identical references.

### DETAILED DESCRIPTION

A propulsion system 1 has a main direction extending along a longitudinal axis X and comprises, from upstream to downstream in the direction of gas flow in the propulsion system 1 when in operation, a fan section 2 and a primary body 3, often called “gas generator”, including a compressor section 4, 5, a combustion chamber 6 and a turbine section 7, 8. The propulsion system 1 is here an aeronautical propulsion system 1 configured to be fixed to an aircraft 100 via a pylon (or mast).

The compressor section 4, 5 comprises a succession of stages each comprising a blade wheel (rotor) 4a, 5a rotating in front of a vane wheel (stator) 4b, 5b. The turbine section 7, 8 also comprises a succession of stages, each comprising a vane wheel (stator) 7b, 8b, behind which a blade wheel (rotor) 7a, 8a rotates.

In the present application, the axial direction corresponds to the direction of the longitudinal axis X, corresponding to the rotation of the gas generator shafts, and a radial direction is a direction perpendicular to this axis X and passing therethrough. Moreover, the circumferential (or lateral or tangential) direction corresponds to a direction perpendicular to the longitudinal axis X and not passing therethrough. Unless otherwise specified, the terms “inner” (respectively, internal) and “outer” (respectively, external), respectively, are used with reference to a radial direction so that the inner portion or face of an element is closer to the axis X than the outer portion or face of the same element.

In operation, an air stream F entering the propulsion system 1 is divided between a primary air stream F1 and a secondary air stream F2, which circulate from upstream to downstream in the propulsion system 1.

The secondary air stream F2 (also called “bypass air stream”) flows around the primary body 3. The secondary air stream F2 cools the periphery of the primary body 3 and serves to generate most of the thrust provided by the propulsion system 1.

The primary air stream F1 flows in a primary path inside the primary body 3, passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6 causes rotation of the rotor of the turbine section 7, 8, which in turn drives in rotation the rotor of the compressor section 4, 5 as well as a rotor portion 9 of the fan section 2.

In a two-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is driven in rotation by the rotor of the high-pressure turbine 7 via a high-pressure shaft 10. The rotor of the low-pressure compressor 4 and the rotor portion 9 of the fan section 2 are driven in rotation by the rotor of the low-pressure turbine 8 via a low-pressure shaft 11. Thus, the primary body 3 comprises a high-pressure body comprising the high-pressure compressor 5, the high-pressure turbine 7 and the high-pressure shaft 10, and a low-pressure body comprising the fan section 2, the low-pressure compressor 4, the low-pressure turbine 8 and the low-pressure shaft 11. The rotation speed of the high-pressure body is greater than the rotation speed of the low-pressure body. In a triple-spool propulsion system 1, the turbine section 7, 8 further comprises an intermediate turbine, positioned between the high-pressure turbine 7 and the low-pressure turbine 8 and configured to drive the rotor of the low-pressure compressor 4 via an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a part of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. As a variant, the low-pressure shaft 11 and the high-pressure shaft are counter-rotating, that is to say driven in opposite directions about the longitudinal axis X. Where appropriate, the intermediate shaft is housed between the high-pressure shaft 10 and the low-pressure shaft 11. The intermediate shaft and the low-pressure shaft 11 may be co-rotating or counter-rotating.

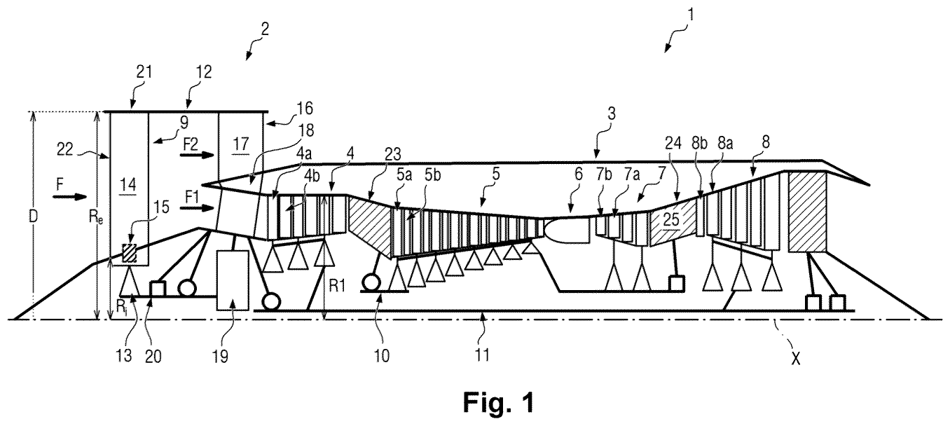

The fan section 2 comprises at least the fan rotor 9 capable of being driven in rotation relative to a stator portion of the propulsion system 1 by the turbine section 7, 8. The fan rotor 9 comprises a hub 13 and blades 14 extending radially from the hub 13. The blades 14 of the rotor 9 may be fixed relative to the hub 12 or have a variable setting. In this case, the root of the blades 14 is pivotally mounted along a setting axis and is connected to a pitch change mechanism 15 mounted in the propulsion system 1, the setting being adjusted according to the flight phases by a pitch change mechanism 15. The pitch change mechanism 15 is illustrated in broken lines in FIG. 1 to show that this characteristic is optional.

The fan section 2 may further comprise a fan stator 16, or straightener, which comprises vanes 17 mounted on a hub 18 of the fan stator 16 which have the function of straightening the secondary air stream F2 which flows at the outlet of the fan rotor 9. The vanes 17 of the fan stator 18 may be fixed relative to the hub 18 or have a variable setting. In a similar manner to the rotor blades 14, the root of the stator vanes 17 is pivotally mounted along a setting axis X and is connected to a pitch change mechanism 15a, which is generally distinct from that of the fan rotor 9, the setting being adjusted according to the flight phases by the pitch change mechanism.

In order to improve the propulsive efficiency of the propulsion system 1 and to reduce its specific consumption as well as the noise emitted by the fan section 2, the propulsion system 1 has a high bypass ratio. By high bypass ratio, it is meant here a bypass ratio greater than or equal to 10, for example comprised between 10 and 35 inclusive. It should be noted that, when the bypass ratio is greater than or equal to 25, the fan rotor 9 is preferably a variable-setting fan rotor. To calculate the bypass ratio, the mass flow rate of the secondary air stream F2 and the mass flow rate of the primary air stream F1 are measured when the propulsion system 1 is stationary, uninstalled, in take-off rating in a standard atmosphere (as defined by the International Civil Aviation Organization (ICAO) manual, Doc 7488/3, 3^{rd} edition) and at sea level (conditions known as SLS, for Seal Level Standard). It should be noted that, in the present application, the parameters (pressure, flow rate, thrust, speed, etc.) are systematically determined under these conditions. By “uninstalled” it is meant here that the measurements are performed when the propulsion system 1 is in a test bench (and uninstalled on an aircraft 100), the measurements then being simpler to make.

The fan rotor 9 is decoupled from the low-pressure shaft 11 using a reduction mechanism 19, placed between an upstream end of the low-pressure shaft 11 and the fan rotor 9, in order to independently optimize their respective rotation speeds. In this case, the propulsion system 1 further comprises an additional shaft, called fan shaft 20. The low-pressure shaft 11 connects the low-pressure turbine 8 to an inlet of the reduction mechanism 19 while the fan shaft 20 connects the outlet of the reduction mechanism 19 to the fan rotor 9. The fan rotor 9 is therefore driven by the low-pressure shaft 11 via the reduction mechanism 19 and the fan shaft 20 at a rotation speed lower than the rotation speed of the low-pressure turbine 8.

This decoupling makes it possible to reduce the rotation speed and the pressure ratio of the fan rotor 9 and to increase the power extracted by the low-pressure turbine 8. Indeed, the overall efficiency of the propulsion systems is conditioned to the first order by the propulsive efficiency, which is favorably influenced by minimizing the variation of the kinetic energy of the air at the crossing of the propulsion system 1. In a propulsion system 1 with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes during the crossing of the fan section 2. The propulsive efficiency and the pressure ratio of the fan section 2 are therefore linked: the lower the pressure ratio of the fan section 2, the better the propulsive efficiency. In order to optimize the propulsive efficiency of the propulsion system 1, the pressure ratio of the fan, which corresponds to the ratio between the average pressure at the outlet of the fan stator 17 and the average pressure at the inlet of the fan rotor 9, is less than or equal to 1.70, preferably less than or equal to 1.50, for example comprised between 1.05 and 1.45. The average pressures are measured here over the height of the blade 14 (from the surface which radially delimits inside the flow path at the inlet of the fan rotor 9 to the tip 21 of the fan blade 14).

The propulsion system 1 is configured to provide a thrust comprised between 18 000 lbf (80 068 N) and 51 000 lbf (22 2411 N), preferably between 20 000 lbf (88964 N) and 35 000 lbf (15 5688 N).

The fan section 2 is ducted and comprises a fan casing 12, the fan rotor 9 being housed in the fan casing 12. The fan rotor 9 extends upstream of the fan stator 16. The vanes 17 of the fan stator 16 are then generally referred to as outlet guide vanes (OGV) and have a fixed setting relative to the hub of the fan stator. Moreover, the bypass ratio of the propulsion system 1 is preferably greater than or equal to 10, for example comprised between 10 and 35 inclusive, preferably between 10 and 18 inclusive. The peripheral speed at the tip 21 of the blades of the fan rotor 9 may also be comprised between 260 m/s and 400 m/s. The blades 14 of the fan rotor 9 may be fixed or have a variable setting. The fan pressure ratio may then be comprised between 1.20 and 1.45.

In an unducted fan section 2, the fan section 2 is not surrounded by a fan casing. Since the fan section 2 is unducted, the blades 14 of the fan rotor 9 have a variable setting. Propulsion systems comprising at least one unducted fan rotor 9 are also known as “open rotor” or “unducted fan”. The propulsion system 1 may comprise two unducted and counter-rotating fan rotors 9. Such a propulsion system 1 is known as CROR for “Contra-Rotating Open Rotor” or UDF for “Unducted Double Fan”. The fan rotor(s) 9 may be placed at the rear of the primary body 3 so as to be of the pusher type or at the front of the primary body 3 so as to be of the tractive type. As a variant, the propulsion system 1 may comprise a single unducted fan rotor 9 and an unducted fan stator 16 (straightener). Such a propulsion system 1 is known as USF for “Unducted Single Fan”. In the case of a USF-type propulsion system 1, the vanes 17 of the straightener 16 are fixed in rotation relative to the axis of rotation X of the upstream fan rotor 9 and therefore do not undergo centrifugal force. The vanes 17 of the straightener 16 are also variable-setting vanes.

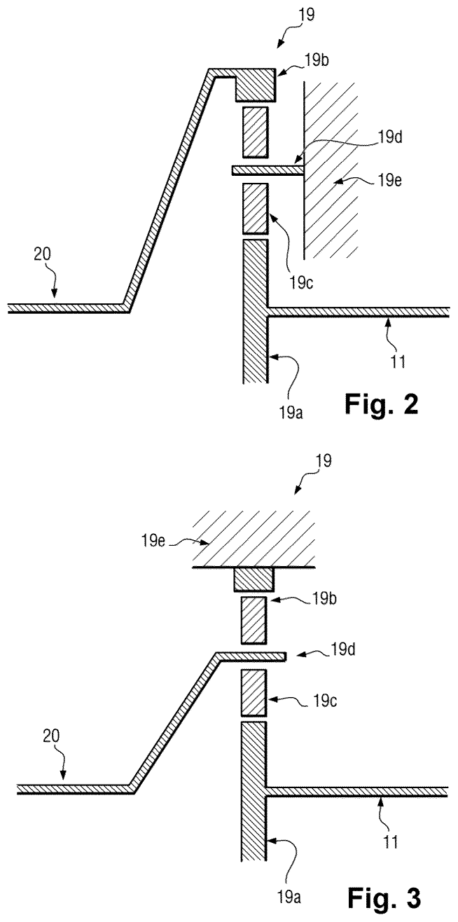

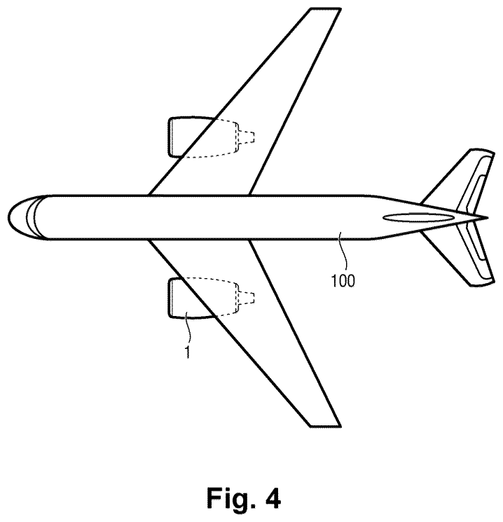

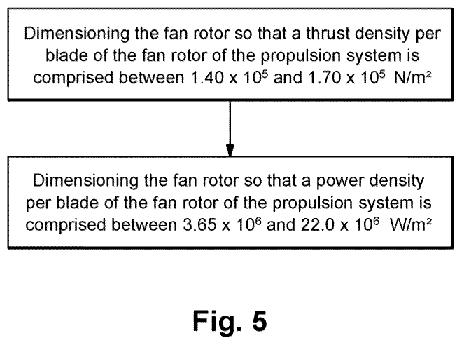

The reduction mechanism 19 may comprise for example a reduction mechanism 19 with a planetary gear train, for example of the “planetary” or “star” type, single-staged or two-staged. According to a first variant, the reduction mechanism 19 may be of the star type (FIG. 2) and comprise a sun gear pinion 19a (inlet of the reduction mechanism 19), centered on an axis of rotation X of the reduction mechanism 19 (generally coincident with the longitudinal axis X) and configured to be driven in rotation by the low-pressure shaft 11, a ring gear 19b (outlet of the reduction mechanism 19) coaxial with the sun gear pinion 19a and configured to drive in rotation the fan shaft 20 about the axis of rotation X, and a series of planet gears 19c distributed circumferentially about the axis of rotation X between the sun gear pinion 19a and the ring gear 19b, each planet gear 19c being meshed internally with the sun gear pinion 19a and externally with the ring gear 19b. The series of planet gears 19c is mounted on a planet gear carrier 19d which is fixed relative to a stator portion 19e of the propulsion system 1, for example relative to a casing of the compressor section 4, 5. According to a second variant, the reduction mechanism 19 can be planetary (FIG. 3), in which case the ring gear 19b is fixedly mounted on the stator portion 19e of the propulsion system 1 and the fan shaft 20 is driven in rotation by the planet gear carrier 19d (which is therefore movable in rotation relative to a stator portion 19e of the propulsion system 1, for example relative to a casing of the compressor section 4, 5).

Regardless of the configuration of the reduction mechanism 19, the diameter of the ring gear 19b and of the planet gear carrier 19d are greater than the diameter of the sun gear pinion 19a, such that the rotation speed of the fan rotor 9 is lower than the rotation speed of the low-pressure shaft 11.

The bypass ratio of the reduction mechanism 19 is greater than or equal to 2.5 and less than or equal to 11, preferably greater than or equal to 2.7 and less than or equal to 6.0, typically around 3.0.

The redline speed of the low-pressure shaft 11, which corresponds to the absolute maximum speed likely to be encountered by the low-pressure shaft 11 during the entire flight (according to the European certification regulation EASA CS-E 740 (or according to the American certification regulation 14-CFR Part 33.87)), is comprised between 8,500 rpm and 12,000 rpm, preferably between 9,000 rpm and 11,000 rpm. The redline speed corresponds to the maximum rotation speed when the propulsion system is sound (and potentially at the end of its life). It is therefore likely to be reached by the low-pressure shaft 11 in flight conditions. This redline speed forms part of the data declared in the engine certification (type certificate data sheet). Indeed, this rotation speed is usually used as a reference speed for the dimensioning of the propulsion systems 1 and in some certification tests (such as blade loss or rotor integrity tests).

In order to optimize the performance of the propulsion system 1 in terms of specific consumption, mass and drag, while ensuring the possibility of integrating the propulsion system 1 into an aircraft 100, the thrust density per blade 14 of the fan rotor 9 is greater than or equal to 1.40×10⁵ and less than or equal to 1.70×10⁵ N/m², where the thrust density per blade 14 is defined by the following formula:

$$Thrust density = \frac{FN}{n * {D}^{2}} * 100$$

and where: FN is the thrust generated by the fan rotor 9 and is expressed in Newton (N);
n is the number of blades 14 in the fan rotor 9; and
D is the diameter of the fan rotor 9, measured in a plane normal to the axis of rotation X at an intersection between a tip 21 and a leading edge 22 of the blades 14 of the fan rotor 9, and is expressed in meters (m). it should be noted that since FIG. 1 is a partial view, the diameter D is only partially visible.

Indeed, the Applicant noticed that, when the thrust density is less than 1.40×10⁵ N/m², it was difficult to integrate the propulsion system 1 because it was too bulky, had too much mass and generated excessive drag. Moreover, when the thrust density is greater than 1.70×10⁵ N/m², the performance of the propulsion system 1 in terms of specific consumption is degraded. The dimensioning of the propulsion system 1 so that the thrust density per blade 14 of the fan rotor 9 is comprised between 1.40×10⁵ and 1.70×10⁵ N/m² therefore makes it possible to obtain a compromise between the integration and the performance of the propulsion system 1 when the propulsion system 1 comprises a reduction mechanism 19 and has a high bypass ratio. Such a thrust density interval per blade 14 is furthermore compatible with a fan pressure ratio of less than 1.45, which makes it possible to optimize the propulsive efficiency of the propulsion system 1.

For example, a propulsion system 1 in accordance with the invention comprising a ducted fan rotor and whose thrust density per fan blade 14 is equal to 1.5×10⁵ N/m² has a specific consumption lower by 5% compared to the same propulsion system whose thrust density per fan blade is equal to 2.1×10⁵ N/m². The thrust density per blade of the propulsion system 1 is influenced to the first order by the diameter D of the fan rotor and the pressure ratio of the fan section 2. The bypass ratio (at a defined fan diameter), the overall compression ratio and the number of stages in the compression and turbine sections generally have little or no impact on the thrust density per blade 14.

Thus, the dimensioning and manufacturing of the propulsion system 1 so as to obtain a power density per blade 14 comprised between 1.40×10⁵ N/m² and 1.70×10⁵ N/m² can be achieved by first fixing the thrust (FN) to be generated with the fan section 2 and by modifying the diameter (D) of the fan rotor (and therefore the pressure ratio of the fan section 2). Compared to a propulsion system with a conventional reduction mechanism, the diameter D can for example be increased and the pressure ratio of the fan 2 can be reduced. The number of fan blades 14 (n) and the rotation speed of the fan rotor 9 can also be adapted in order to meet performance, acoustic and integration requirements. Depending on the aerodynamic characteristics of the fan section 2, the propulsion system 1 can be modified so as to integrate a pitch change mechanism 15, 15a making it possible to adapt the setting of the blades 14 of the rotor 9 (and possibly the vanes 16 of the stator 17) of the fan section 2. Finally, the thermodynamic cycle is adapted to the various parameters thus dimensioned (fan diameter, number of blades, pressure ratio of the fan section 2, etc.) of the propulsion system 1: particularly the flow rate of the gas generator can be reduced and the bypass ratio of the reduction mechanism 19 can be increased.

For thrust densities per blade 14 comprised between 1.40×10⁵ N/m² and 1.70×10⁵ N/m², the diameter D of the fan rotor can then be comprised between 80 inches (203.2 cm) and 120 inches (304.8 cm) inclusive, for example of the order of 90 inches (228.6 cm), which makes it possible to integrate the propulsion system 1 in a conventional manner, particularly under the wing of an aircraft 100.

The fan rotor 9 moreover comprises at least twelve blades 14 and at most twenty-four blades 14, preferably at least sixteen blades 14 and at most twenty-two blades 14. The number of vanes 16 in the fan stator 17 depends on the acoustic criteria defined for the propulsion system 1 and is at least equal to the number of blades 14 of the fan rotor 9.

In order to further improve the propulsive efficiency of the propulsion system 1, the power density per blade 14 of the fan rotor 9 is greater than or equal to 3.65×10⁶ and less than or equal to 22.0×10⁶ W/m², preferably greater than or equal to 16.0×10⁶ and less than or equal to 22.0×10⁶ W/m², where the power density per blade 14 of the fan rotor 9 is defined by the following formula:

$$Power density = \frac{power of the fan}{n * {D}^{2}} * 100$$

where the fan power corresponds to the power of the fan rotor 9 and is expressed in Watts (W).

The fan rotor 9 also has a hub-to-tip ratio comprised between 0.22 and 0.32. In the case of a fixed-setting fan rotor, the hub-to-tip ratio may be comprised between 0.24 and 0.32. In the case of a variable-setting fan rotor, the hub-to-tip ratio is preferably comprised between 0.26 and 0.32 in order to allow the integration of the pitch change mechanism 15. The hub-to-tip ratio corresponds to the ratio between the inner radius R, and the outer radius Rₑ of the fan rotor 9. The inner radius R, corresponds to the distance between the axis of rotation X and the point of intersection between the leading edge 22 and the surface which radially delimits on the inside the flow path at the inlet of the fan rotor 9 (and corresponds to the point of connection of the leading edge 22 with the aerodynamic surface of a platform of the fan rotor 9). The outer radius Rₑ corresponds to the distance between the axis of rotation X and the point of intersection between the leading edge 22 and the tip 21 of the fan blades (and corresponds to half the fan diameter D). The lower the hub-to-tip ratio, the more efficient the fan rotor 9 is. However, the reduction of the hub-to-tip ratio of the fan rotor 9 implies an increase in the mechanical load on the hub 13 of the fan rotor 9. The dimensioning of the fan rotor 9 such that its hub-to-tip ratio is comprised between 0.22 and 0.32 particularly makes it possible to obtain a thrust density and a power density per blade 14 within the intervals defined above.

A two-spool propulsion system 1 having a thrust density and a power density per blade 14 of the fan rotor 9 in the intervals defined above may in particular comprise a two-stage high-pressure turbine 7, a high-pressure compressor 5 comprising at least eight stages and at most eleven stages, a low-pressure turbine 8 comprising at least three stages and at most five stages and a low-pressure compressor 4 comprising at least two stages and at most four stages.

### Comparative Example

Engine 1 is a two-spool propulsion system comprising a ducted fan section 2 corresponding to the current technical standard (on the filing date of the present application) that is being sought to be improved.

Engine 2 is a two-spool propulsion system 1 comprising a ducted fan section 2 conforming to the teaching of the present application with a thrust density per fan blade equal to 1.49×10⁵ N/m².

| Dimensioning parameter | | | Engine 2 | |
|---|---|---|---|---|
| (SLS unless otherwise | Engine 1 | | (according to the disclosure | |
| stated) | (reference engine) | | of the present application) | |
| fan thrust FN | 158 800N | (35 700 klbf) | 156 800N | (35 190 lbf) |
| Diameter D | 2.11 m | (83 in.) | 2.413 m | (95 in.) |
| Number of blades n | 18 | | 18 | |
| Thrust density per blade | 1.98 × 10⁵ | | 1.49 × 10⁵ | N/m² |
| Power of the fan | 21 297 798 | W | 20 889 407 | W |
| Pressure ratio of the fan | 1.43 | | 1.37 | |
| Power density per blade | 2.66 × 10⁷ | W/m² | 1.99 × 10⁷ | W/m² |
| Bypass ratio BPR | 11.0 | | 12.0 | |
| Peripheral speed of the blades | 346 | m/s | 343 | m/s |
| 14 | | | | |
| Hub-to-tip ratio | 0.30 | | 0.30 | |
| Redline of the fan rotor 9 | 3 284 | tr/min | 2,842 | tr/min |
| Redline of the high-pressure | 19 888 | tr/min | 19 741 | tr/min |
| shaft 10 | | | | |
| Redline of the low-pressure | 8 962 | tr/min | 10 143 | tr/min |
| shaft 11 (N₁) | | | | |
| Compression ratio of the low- | 1.85 | | 1.85 | |
| pressure compressor | | | | |
| Overall compression ratio | 42 | | 50 | |
| Reduction ratio | 2.73 | | 3.57 | |
| Number of stages of the low- | 2 | | 2 | |
| pressure compressor 4 | | | | |
| Number of high-pressure | 10 | | 10 | |
| compressor stages 5 | | | | |
| Number of high-pressure | 2 | | 2 | |
| turbine stages 7 | | | | |
| Number of low-pressure turbine | 4 | | 3 | |
| stages 8 | | | | |
| Temperature at the inlet of the | 1,577° | C. | 1,627° | C. |
| high-pressure turbine 7 | | | | |
| Temperature at the inlet of the | 1,027° | C. | 1,024° | C. |
| low-pressure turbine 8 (redline) | | | | |
| N₁²S | 36.7 × 10⁶ | (tr/min)² · m² | 48.6 × 10⁶ | (tr/min)² · m² |

(where S is the outlet section of
the low-pressure turbine 8)

The engine 1 has a thrust density per fan blade greater than 1.70×10⁵ N/m² while the engine 2 has a thrust density per fan blade comprised between 1.40 and 1.70×10⁵ N/m². It appears that, thanks to its improved thrust density per blade, the engine 2 has better specific consumption than the engine 1, without requiring an increase in the inlet temperature of the low-pressure turbine. The efficiency of fan section 2 has therefore been improved without the need to further load the low-pressure turbine.

To move from the (reference) engine 1 to the engine 2 (consistent with the disclosure), the fan diameter D and the bypass ratio BPR were increased, which made it possible to improve the propulsive efficiency and maintain comparable thrust given the reduction of the pressure ratio of the fan 2. Moreover, the overall compression ratio was increased, as well as the inlet temperature of the high-pressure turbine 7, which made it possible to increase the thermal efficiency of the propulsion system 1. Finally, insofar as the temperature of the low-pressure turbine 8 was kept stable, it was possible to increase its mechanical loading (N₁₂S) and therefore reduce the number of stages.

1. A propulsion system comprising:
a drive shaft movable in rotation about an axis of rotation;
a fan shaft;
a fan section comprising a ducted fan rotor driven in rotation by the fan shaft, the fan rotor comprising a plurality of blades; and
a reduction mechanism coupling the drive shaft and the fan shaft in order to drive the fan shaft at a rotation speed lower than the rotation speed of the drive shaft;
a thrust density per blade of the fan rotor of the propulsion system being greater than or equal to 1.40×10⁵ and less than or equal to 1.70×10⁵ N/m² where the thrust density per blade is defined by the following formula:
$$Thrust density = \frac{FN}{n * {D}^{2}} * 100$$
and where: FN is a thrust generated by the fan rotor and is measured when the propulsion system is stationary in take-off rating in a standard atmosphere and at sea level and is expressed in Newton;
n is a number of blades in the fan rotor; and
D is a diameter of the fan rotor, measured in a plane normal to the axis of rotation at an intersection between a tip and a leading edge of the blades of the fan rotor, and is expressed in meters.

2. The propulsion system according to claim 1, wherein a power density per blade of the fan rotor is greater than or equal to 3.65×10⁶ and less than or equal to 22.0×10⁶ W/m², where the power density per blade of the fan rotor is defined by the following formula:
$$Power density = \frac{power of the fan}{n * {D}^{2}} * 100$$
and where the power of the fan corresponds to the power of the fan rotor and is measured when the propulsion system is stationary in take-off rating in a standard atmosphere and at sea level and is expressed in Watts.

3. The propulsion system according to claim 1, wherein the fan section further has a fan compression ratio, corresponding to a pressure ratio between an outlet of the fan rotor and an inlet of the fan rotor less than or equal to 1.45.

4. The propulsion system according to claim 1, wherein the diameter of the fan rotor is comprised between 80 inches and 120 inches inclusive.

5. The propulsion system according to claim 1, wherein a bypass ratio of the propulsion system is comprised between 10 and 35 inclusive.

6. The propulsion system according to claim 1, wherein a peripheral speed at the tip of the blades of the fan rotor, when the propulsion system is stationary in take-off rating in a standard atmosphere and at sea level, is comprised between 260 m/s and 400 m/s.

7. The propulsion system according to claim 1, wherein a hub-to-tip ratio of the fan rotor is comprised between 0.22 and 0.32.

8. The propulsion system according to claim 1, further comprising a drive turbine and a compressor directly connected by the drive shaft, the drive turbine comprising at least three and at most five stages.

9. The propulsion system according to claim 8, wherein the compressor comprises at least two and at most four stages.

10. The propulsion system according to claim 1, further comprising a high-pressure turbine and a high-pressure compressor connected via a high-pressure shaft, the high-pressure shaft being configured to rotate faster than the drive shaft, the high-pressure turbine being two-stage turbine.

11. The propulsion system according to claim 10, wherein the high-pressure compressor comprises at least eight and at most eleven stages.

12. An aircraft comprising at least one propulsion system according to claim 1, fixed to the aircraft via a pylon.

13. A method for dimensioning a propulsion system comprising a reduction mechanism coupling a drive shaft and a ducted fan rotor to drive the fan rotor at a speed lower than a speed of the drive shaft, wherein the fan rotor is dimensioned such that a thrust density per blade of the fan rotor of the propulsion system is greater than or equal to 1.40×10⁵ and less than or equal to 1.70×10⁵ N/m² where the thrust density per blade of the fan rotor is defined by the following formula:
$$Thrust density = \frac{FN}{n * {D}^{2}} * 100$$
and where: FN is a thrust of the fan rotor and is measured when the propulsion system is stationary in take-off rating in a standard atmosphere and at sea level and is expressed in Newton;
n is a number of blades in the fan rotor; and
D is a fan diameter, measured in a plane normal to the axis of rotation at an intersection between a tip and a leading edge of the blades of the fan rotor, and is expressed in meters.

14. A dimensioning method according to claim 13, wherein the fan rotor is further dimensioned such that a power density per blade of the fan rotor is greater than or equal to 3.65×10⁶ and less than or equal to 22.0×10⁶ W/m², wherein the power density per blade of the fan rotor is defined by the following formula:
$$Power density = \frac{power of the fan}{n * {D}^{2}} * 100$$
and where the power of the fan rotor is measured when the propulsion system is stationary in take-off rating in a standard atmosphere and at sea level and is expressed in Watts.

15. A method for manufacturing a propulsion system comprising:
dimensioning the propulsion system according to claim 13; and
manufacturing the propulsion system.

16. The propulsion system according to claim 1, wherein a power density per blade of the fan rotor is greater than or equal to 16.0×10⁶ and less than or equal to 22.0×10⁶ W/m², where the power density per blade of the fan rotor is defined by the following formula:
$$Power density = \frac{power of the fan}{n * {D}^{2}} * 100$$
and where the power of the fan corresponds to the power of the fan rotor and is measured when the propulsion system is stationary in take-off rating in a standard atmosphere and at sea level and is expressed in Watts.

17. The propulsion system according to claim 1, wherein the diameter of the fan rotor is equal to 90 inches.

18. The propulsion system according to claim 1, wherein a bypass ratio of the propulsion system is comprised between 10 and 18 inclusive.

19. The dimensioning method according to claim 13, wherein the fan rotor is further dimensioned such that a power density per blade of the fan rotor is greater than or equal to 16.0×10⁶ and less than or equal to 22.0×10⁶ W/m², wherein the power density per blade of the fan rotor is defined by the following formula:
$$Power density = \frac{power of the fan}{n * {D}^{2}} * 100$$
and where the power of the fan rotor is measured when the propulsion system is stationary in take-off rating in a standard atmosphere and at sea level and is expressed in Watts.
